(19) United States
(12) Patent Application Publication
(10) Pub. No.: US 2026/0153024 A1
(43) Pub. Date: Jun. 4, 2026

(54) System and Method for Mud Motor Stall Detection and Recovery

(71) Applicant: Patterson-UTI Drilling Company LLC, Houston, TX (US)

(72) Inventors: Alexander Michael Groh, Hockley, TX (US); Weidong Li, Bellaire, TX (US)

(21) Appl. No.: 19/457,997

(22) Filed: Jan. 23, 2026

Related U.S. Application Data
(63) Continuation-in-part of application No. PCT/US23/36864, filed on Nov. 6, 2023.
(60) Provisional application No. 63/515,450, filed on Jul. 25, 2023.

(51) Int. Cl. E21B 44/06; E21B 21/08

(52) U.S. Cl. CPC E21B 44/06; E21B 21/08

(57) ABSTRACT

A method and a system for detecting a motor stall includes obtaining, in real time, actual or calculated values of sensors comprising at least one of a top drive torque value, a differential pressure value, a surface weight on bit value, or a top drive rotational velocity value and computing a spline representation of the sensor values or derivatives of the sensor values to obtain a spline data set. Further, the method includes determining a presence of the motor stall using the spline data set.

### CROSS-REFERENCE TO RELATED APPLICATIONS

This application is a continuation-in-part of International Application No. PCT/US23/36864, filed Nov. 6, 2023, which claims priority to U.S. Provisional Patent Application No. 63/515,450 , filed Jul. 25, 2023, the disclosure of each of which is incorporated by reference herein in its entirety.

### BACKGROUND

A mud motor stall is a common problem in the drilling industry that occurs when a positive displacement motor (i.e. mud motor) fails to rotate or turns at a slower speed than expected. This can be caused by a number of factors, including but not limited to damaged or worn-out motor components, high torque demands on the motor that exceed its capacity, and excessive heat or friction on the motor due to drilling conditions or poor cooling.

One common cause of drilling motor stalls is excessive torque. This may happen when the bit is loaded with too much weight or there is excessive resistance from the formation being drilled. The motor cannot keep up with the demands of the drill bit, and rotation stops. High ambient temperature may also cause motor stalls by expanding internal components such as elastomers in the power section of the motor, reducing tolerances and increasing friction. Finally, mechanical issues may cause motor stalls. This may include problems with the bearings or other parts of the motor that are essential to its operation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method for detecting a motor stall. The method includes obtaining, in real time, actual or calculated values of sensors comprising at least one of a top drive torque value, a differential pressure value, a surface weight on bit value, or a top drive rotational velocity value and computing a spline representation of the sensor values or derivatives of the sensor values to obtain a spline data set. Further, the method includes determining a presence of the motor stall using the spline data set.

In general, in one aspect, embodiments disclosed herein relate to a non-transitory computer readable medium storing a set of instructions executable by a computer processor for detecting a motor stall. The set of instructions includes the functionality for obtaining, in real time, actual or calculated values of sensors comprising at least one of a top drive torque value, a differential pressure value, a surface weight on bit value, or a top drive rotational velocity value and computing a spline representation of the sensor values or derivatives of the sensor values to obtain a spline data set. The instructions also include functionality for determining a presence of the motor stall using the spline data set.

In general, in one aspect, embodiments disclosed herein relate to a system including a plurality of sensors and a motor stall detector comprising a computer processor, wherein the motor stall detector is coupled to the plurality of sensors, the motor stall detector comprising functionality for obtaining, in real time, actual or calculated values of sensors comprising at least one of a top drive torque value, a differential pressure value, a surface weight on bit value, or a top drive rotational velocity value and computing a spline representation of the sensor values or derivatives of the sensor values to obtain a spline data set. The motor stall detector also includes functionality for determining a presence of the motor stall using the spline data set.

Other aspects and advantages will be apparent from the following description and the appended claims.

### BRIEF DESCRIPTION OF DRAWINGS

Wherever possible, like or identical reference numerals are used in the figures to identify common or the same elements. The figures are not necessarily to scale and certain features and certain views of the figures may be shown exaggerated in scale for purposes of clarification.

FIG. 1 shows a system according to embodiments of the disclosure.

FIG. 2 shows a flowchart in accordance with one or more embodiments.

FIG. 3 shows an exemplary flowchart for a method for motor stall detection in accordance with one or more embodiments.

FIGS. 4A-B show non-stall graphs according to embodiments of the disclosure.

FIGS. 4C-D show stall graphs according to embodiments of the disclosure.

FIG. 5 shows a computer system in accordance with one or more embodiments.

### DETAILED DESCRIPTION

In the following detailed description of embodiments disclosed herein, numerous specific details are set forth in order to provide a more thorough understanding of the invention disclosed herein. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

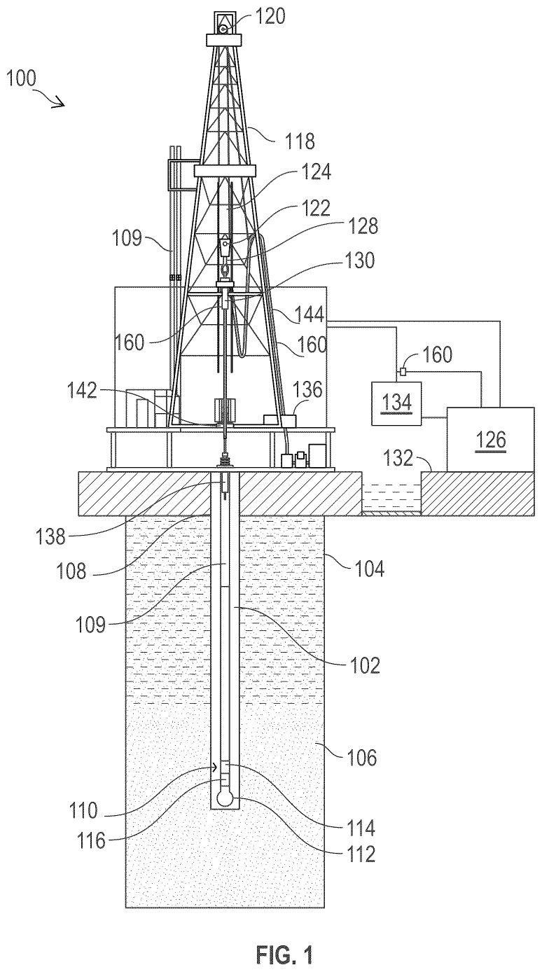

In the following description of FIGS. 1-5, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Embodiments disclosed herein provide a method and system for motor stall detection and recovery. Specifically, the method uses drilling sensors to monitor drilling operations and provide a safety mechanism to stop or warn an equipment operator about a predicted motor stall or initiate an automated recovery sequence. In one or more embodiments, the drilling sensors may include at least one of the following: a weight on bit sensor that measures the weight being applied to the drill bit during drilling operations, a torque sensor that measures the torque being applied to the drill bit during drilling operations, a pressure sensor that measures the pressure of the drilling fluid being pumped into the wellbore, or a rotational speed sensor that measures the rotary speed of the top drive.

In one or more embodiments, this method may be implemented on already existing hardware packages as a plug-in module. The plug-in module may be deployed on an existing drill controller setup. Initially the hardware package may be deployed as a standalone setup, with an interface provided to the driller to run a Graphical User Interface (GUI). That ensures that the development and roll-out phase of the project are easier to implement, without requiring a permanent rig fixture. Alternatively, the system may be integrated directly to the drill rig to form a stopping mechanism to stop the stop the drilling operation in the event of an unsafe situation.

The method uses techniques including modelling and software based on artificial intelligence (AI) models, including machine learning. The data obtained by the drilling sensors (including actual and/or calculated values) are fed into processing systems that are pretrained with previous drilling operation data. The machine learning model also analyzes obtained data in real time.

To implement an automated recovery process for motor stalls, a reliable algorithm to detect these stalls is required. Simple and more traditional methods were attempted towards this goal when initially investigating this problem, and these methods yielded results with an accuracy that is as less than 50%, mainly due to a large amount of false-positive detections. The proposed method improves the accuracy of the detection significantly, providing more confidence that a detected stall is real when the automation routine is started.

Additionally, having a low reaction time is important to respond quickly to a stall event. While the traditional methods have a longer reaction time, the proposed method detects motor stalls within 400 milliseconds to 4 seconds depending on the stall severity and depth that it occurred at.

FIG. 1 shows a well site (100) in accordance with one or more embodiments. The well site (100) shown in FIG. 1 is used as an example well site as well sites may be configured in a myriad of ways. Therefore, the well site (100) is not intended to be limiting with respect to the particular configuration of the drilling equipment. The well site (100) is depicted as being on land. In other examples, the well site (100) may be offshore, and drilling may be carried out with or without use of a marine riser. A drilling operation at well site (100) may include drilling a wellbore (108) into a subsurface including various formations (104, 106). For the purpose of drilling a new section of wellbore (108), a drill string (102) is suspended within the wellbore (108).

The drill string (102) may include one or more drill pipes (109) connected to form conduit and a bottom hole assembly (BHA) (110) disposed at the distal end of the conduit. The BHA (110) may include a drill bit (112) to cut into the subsurface rock. The BHA (110) may include measurement tools, such as a measurement-while-drilling (MWD) tool (114) and mud motor (116). Measurement tools (114, 116) may include sensors and hardware to measure downhole drilling parameters, and these measurements may be transmitted to the surface using any suitable telemetry system known in the art. The BHA (110) and the drill string (102) may include other drilling tools known in the art but not specifically shown.

The drill string (102) may be suspended in wellbore (108) by a derrick (118). A crown block (120) may be mounted at the top of the derrick (118), and a traveling block (122) may hang down from the crown block (120) by means of a cable or drilling line (124). One end of the cable (124) may be connected to a draw works (136), which is a reeling device that can be used to adjust the length of the cable (124) so that the traveling block (122) may move up or down the derrick (118).

The traveling block (122) may include a hook (128) on which a top drive (130) is supported. The top drive (130) is coupled to the top of the drill string (102) and is operable to rotate the drill string (102). Alternatively, the drill string (102) may be rotated by means of a rotary table (142) on the drilling floor. Drilling fluid (commonly called mud) may be stored in a mud pit (132), and at least one pump (134) may pump the mud from the mud pit (132) into the drill string (102). The mud may flow into the drill string (102) through appropriate flow paths in the top drive (130) (or a rotary swivel, if a rotary table is used instead of a top drive to rotate the drill string (102).

In one implementation, a rig control system (126) may be disposed at or communicate with the well site (100). The rig control system (126) may control at least a portion of a drilling operation at the well site (100) by providing controls to various components of the drilling operation. A data acquisition system and a motor stall detector may reside in the driller's cabin (not shown), which is part of the rig control system (126). In one or more embodiments, rig control system (126) may receive data from one or more sensors (160) arranged to measure controllable parameters of the drilling operation. As a non-limiting example, sensors (160) may be arranged to measure WOB (weight on bit), RPM (drill string rotational speed), GPM (flow rate of the mud pumps), and ROP (rate of penetration of the drilling operation). Additionally, the drilling sensors may include, at least one of the following, a torque sensor the measures the torque being applied to the drill string during drilling operations and a pressure sensor that measures the pressure of the drilling fluid being pumped into the wellbore.

Sensors (160) may be positioned to measure parameter(s) related to the rotation of the drill string (102), parameter(s) related to travel of the traveling block (122), which may be used to determine ROP of the drilling operation, and parameter(s) related to flow rate of the pump (134). For illustration purposes, sensors (160) are shown on top drive (130), standpipe manifold (144), and proximate mud pump (134). More specifically, the torque and rotation are measured at the top drive (130). The flow is measured at the mud pump (134). Pressure is measured at the standpipe manifold (144). The illustrated locations of sensors (160) are not intended to be limiting, and sensors (160) could be disposed wherever drilling parameters need to be measured. Moreover, there may be many more sensors (160) than shown in FIG. 1 to measure various other parameters of the drilling operation. Each sensor (160) may be configured to measure a desired physical stimulus.

During a drilling operation at the well site (100), the drill string (102) is rotated relative to the wellbore (108), and weight is applied to the drill bit (112) to enable the drill bit (112) to break rock as the drill string (102) is rotated. In some cases, the drill bit (112) may be rotated independently with a drilling motor. In further embodiments, the drill bit (112) may be rotated using a combination of the drilling motor and the top drive (130) (or a rotary swivel if a rotary table is used instead of a top drive to rotate the drill string (102)).

While cutting rock with the drill bit (112), mud is pumped into the drill string (102). The mud flows down the drill string (102) and exits into the bottom of the wellbore (108) through nozzles in the drill bit (112). The mud in the wellbore (108) then flows back up to the surface in an annular space between the drill string (102) and the wellbore (108) with entrained cuttings. The mud with the cuttings is returned to the pit (132) to be circulated back again into the drill string (102). Typically, the cuttings are removed from the mud, and the mud is reconditioned as necessary, before pumping the mud again into the drill string (102). In one or more embodiments, the drilling operation may be controlled by the rig control system (126).

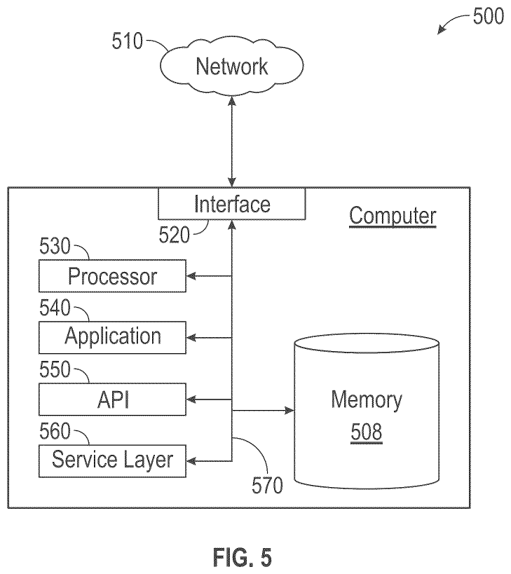

In some embodiments, the rig control system (126) includes the motor stall detector. For example, the motor stall detector may include hardware and/or software with functionality for generating one or more instructions to the user or to the system, predicting the motor stall, reporting a prediction to the user, stopping the drilling system before the stall occurs, and facilitating a maintenance operation of the drilling motor. For example, the motor stall detector may store the drilling sensors'logs and parameters determined using the machine learning models. For this purpose, the motor stall detector may include memory with one or more data structures, such as a buffer, a table, an array, or any other suitable storage medium. While the motor stall detector is shown at a well site, in some embodiments, the motor stall detector may be located remotely from well site. In some embodiments, the motor stall detector may include a computer system that is similar to the computer system (500) described below with regard to FIG. 5 and the accompanying description.

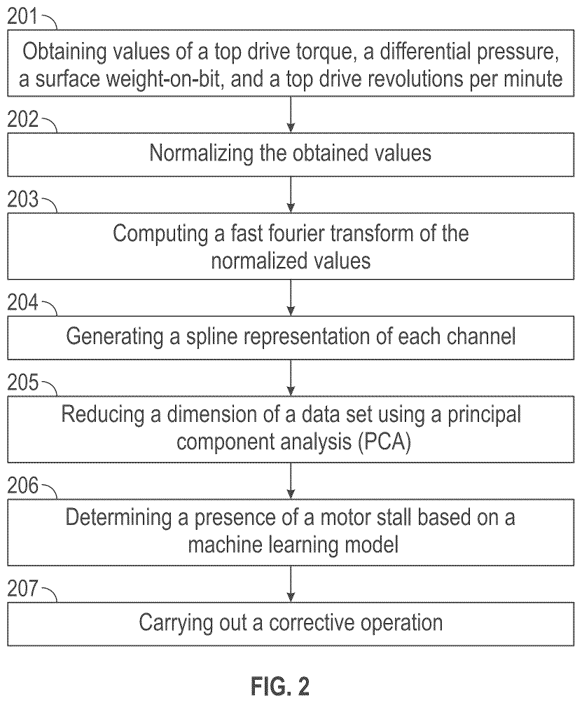

FIG. 2 shows a flowchart in accordance with one or more embodiments for detecting a motor stall. One or more blocks in FIG. 2 may be performed by one or more components (e.g., motor stall detector) as described in FIG. 1. While the various blocks in FIG. 2 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Specifically, in Block 201, drilling data are obtained regarding a drilling operation at a wellbore in accordance with one or more embodiments. The drilling operation parameters may include one or more of the following: weight on bit, the top drive torque, the mud pressure, or the top drive rotation rate. The drilling data regarding a drilling operation at a wellbore may be obtained in real time from various drilling sensors and other data sources.

In one or more embodiments, the drilling operation parameters may be obtained in separate channels and at a predetermined rate (e.g., 200 milliseconds) or variable rate. The four initial input channels may receive data regarding torque, differential pressure, weight on bit, and top drive revolutions per minute or rotational velocity. This obtained data for each drilling operation parameter is temporarily stored, in a process of caching, in rolling time windows of a predetermined duration (e.g., 2.5 minutes). The real-time caching includes capturing and processing data as it is obtained and storing the data in a cache for quick access. Caching may be done using technologies such as in-memory databases, or distributed caches. By caching data in real time, a latency may be reduced and the overall performance of the system may be improved.

In Block 202, when the time of obtaining drilling data reaches the predetermined duration, the rolling time window is divided into two smaller time windows (e.g., 2 minutes and 30 seconds). The data in the first smaller window is used to normalize new values of the obtained drilling data. The normalization is used to transform data to have a standard scale and to be more comparable across different datasets.

In one or more embodiments, the normalization process may be computed using a mean and a standard deviation. Initially, the mean is calculated by summing all data points and dividing the sum with a total number of data points. The standard deviation is calculated by finding the square root of the variance, the variance being the sum of the squared differences between each data point and the mean divided by the total number of data points minus one. Further, the mean is subtracted from each data point to center the data around zero and each centered data point is divided by the standard deviation to scale the data. The normalized data is cached in unform windows, with a duration smaller than the duration of the first smaller window, that will be used in Blocks 203-206.

In Block 203, the normalized data for each parameter is processed using a Fast Fourier Transform (FFT) to obtain FFT values. The FFT is an algorithm for converting a time-domain signal into its frequency-domain representation. The FFT works by taking a discrete-time signal and decomposing it into a set of complex sinusoids with varying magnitudes and phases. The resulting spectrum shows the amplitude and phase information of each sinusoidal component of the original signal. Specifically, the FFT algorithm divides the input signal into smaller sub-signals, applies the Fourier transform to each sub-signal, and then combines the results. The algorithm takes advantage of symmetries in the computation of the Discrete Fourier Transform to reduce the number of calculations required. The FFT may be used to filter out unwanted noise, identify frequencies of interest, and extract information from complex signals. This utilization of FFT data of parameters, allows it to differentiate changes in parameters that are periodic, (e.g., a result of stick slip) versus those that are from stalls.

In Block 204, a spline representation is generated for each channel of the normalized values and the FFT values to obtain a spline data set. The spline may be a cubic B-spline representation, which is a mathematical curve that is defined by a set of control points (otherwise known as “knots”) and a set of basis functions and may be used to represent smooth curves. The basis functions used in a cubic B-spline are polynomials that are defined piecewise over the interval between adjacent control points. The polynomial functions are joined together smoothly at the control points to ensure a smooth curve. This process generates a set of coefficients of a piece-wise polynomial curve that are highly related to the shape of the curve.

Further, an advantageous application of the cubic B-splines is that they can be easily modified by adding or removing control points. The cubic B-splines also provide a good balance between flexibility and efficiency, making them well-suited for real-time applications. This makes the cubic B-splines suitable for applications where the shape of the curve needs to be adjusted frequently.

In Block 205, a dimension of the spline data set is reduced using a principal component analysis (PCA) to obtain a reduced spline data set. The PCA identifies the underlying structure in the data, using a covariance matrix, and transforms it into a new set of variables called principal components, which are linear combinations of the original variables. Further, the PCA identifies the directions in which the data varies the most, by calculating and ranking eigenvectors and eigenvalues, and then projects the data onto these directions, in a way that the first principal component is the direction in which the data varies the most, the second principal component is the direction orthogonal to the first component in which the data varies the most, etc.

In Block 206, the reduced spline data set is inputted into a machine learning model to predict the presence of the motor stall. The machine learning model may be based on any type of supervised machine learning technique. Examples may include but are not limited to perceptrons, convolutional neural networks, deep neural networks, recurrent neural networks, support vector machines, decision trees, linear regression or derivatives of linear regression, etc. may be used. In some embodiments, two or more different types of machine-learning models are integrated into a single machine-learning architecture, e.g., a machine-learning model may include support vector machines and neural networks.

In some embodiments, decision trees algorithms may be used to predict the presence of a stall. The decision trees algorithms may use a tree-like structure to represent possible outcomes and their consequences based on a series of decisions or conditions. A decision tree consists of nodes that represent a decision, an outcome, or a test of a specific condition. Each node has one or more branches, each representing a possible path or outcome. The decision-making process is based on a set of rules that lead to a final decision or prediction. There are different types of decision trees, including classification trees and regression trees. Classification trees are used for predicting a categorical target variable, while regression trees are used for predicting a continuous target variable.

In one or more embodiments, XGBoost may be used as a decision tree-based machine learning program. XGBoost is a decision tree-based ensemble machine learning algorithm that uses the gradient boosting framework to build predictive models. Specifically, in XGBoost, the decision trees are used as base learners, and the model is trained by iteratively adding trees that correct the errors of the previous trees. Each decision tree in XGBoost is built to predict the residuals or errors of the previous tree, and the final prediction is obtained by adding up the predictions of all the trees in the ensemble. Further, XGBoost also includes several advanced features, such as regularization, parallel processing, and handling of missing data, that improve the performance and scalability of the algorithm.

The selection of the machine learning model may involve selecting the machine learning model with the best performance based on the training of the method. The machine learning model with the best performance may be identified through repeated execution of steps using different machine learning models, until the best-performing machine learning model is identified.

In one or more embodiments, XGBoost is a model used as the machine learning model to predict the probability of a motor stall having occurred. Specifically, the XGBoost is pretrained using historical data. The historical data includes data measured during a plurality of previously drilled wells that is manually labeled in time for a stall condition. The output of the XGBoost machine learning model is a probability of the motor stall occurring. Further, a threshold, at which a stall prediction is raised, is chosen to balance between the frequencies of false positive and false negative detections.

In one or more embodiments, when the output of the machine learning model meets or exceeds the threshold value, a stall prediction is raised. In some embodiments, when the stall prediction is raised, the system may notify the user that the probability of the motor stall met or exceeded the threshold. Further, a report including, at least, values of individual channels may be generated for the user's review. Alternatively and/or additionally, the system may instigate an automatic shutdown when the stall prediction is raised.

In Block 207, a corrective operation is carried out when the stall prediction is raised. Specifically, the corrective operation may include, for example, stopping lowering of a drill string, reducing or releasing a torque, reducing a weight on bit, reducing a pump flow rate, stopping a top drive rotation, picking up the drill string, or turning off one or more pumps. Maintenance operations may include replacing or refurbishing motor components (e.g., to provide sufficient power supply to the motor or to lubricate the motor) and replacing damaged or worn-out motor components. In another example, the maintenance operation may include an electronic signal sent to an automated maintenance system for procuring and delivering motor components to a system site for performing a maintenance operation of replacing or refurbishing the motor components.

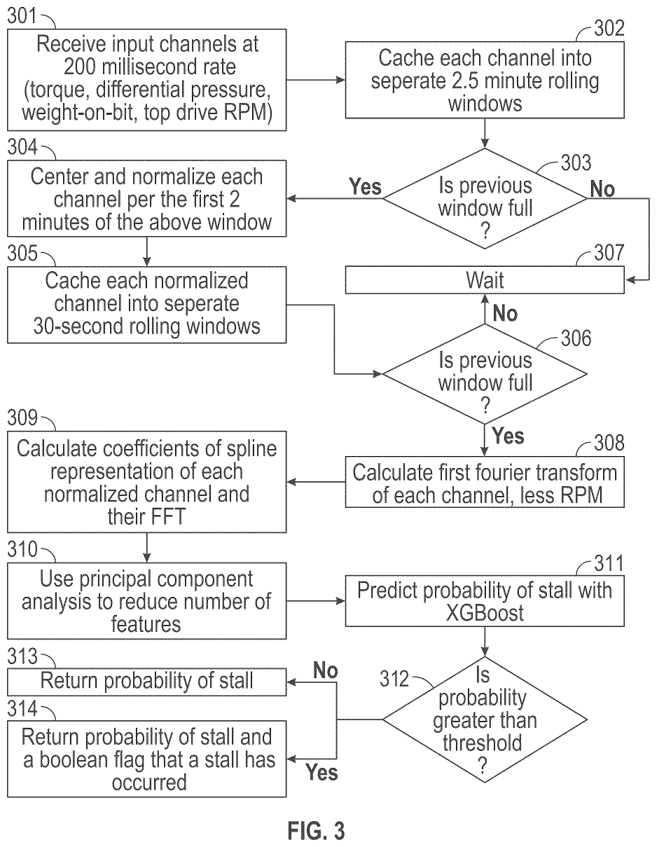

FIG. 3 shows a flowchart in accordance with one or more embodiments. Further to the general description provided in FIG. 2, FIG. 3 shows an exemplary flowchart, which illustrates a method for detecting a motor stall. Further, one or more blocks in FIG. 3 may be performed by one or more components as described in FIGS. 1 and 2. While the various blocks in FIG. 3 are presented and described sequentially, one of ordinary skill in the art will appreciate that some or all of the blocks may be executed in a different order, may be combined or omitted, and some or all of the blocks may be executed in parallel. Furthermore, the blocks may be performed actively or passively.

Initially, in Step 301, drilling data are obtained regarding a drilling operation at a wellbore in accordance with one or more embodiments. The drilling data may include the torque, the differential pressure, the weight on bit, and a top drive rotations per minute. The drilling data regarding a drilling operation at a wellbore may be obtained in real time from various drilling sensors and other data sources. Further, the data may be obtained in separate channels, for each parameter, and at a predetermined rate of 200 milliseconds.

In Step 302, the obtained data for each parameter is temporarily stored, in a process of caching, in rolling time windows in a duration of 2.5 minutes. The real-time caching includes capturing and processing data as it is obtained and storing the data in a cache for quick access. The rolling time windows are initially empty.

In Step 303, a determination is made based on whether the 2.5 minutes rolling time window is full. When the rolling time window is full, in Step 304, the data is normalized. The normalization process is computed by calculating the mean and the standard deviation of the first 2 minutes of the rolling time window. Further, all data values are subtracted by the mean and divided by the standard deviation.

In Step 305, the normalized data is cached in continuous rolling time windows of 30 second durations. The 30 second rolling time windows are used in steps 305-314. In Step 306, a determination is made based on whether the 30 second rolling time window is full. For Steps 303 and 306, when the rolling windows are not full, the system waits in Step 307, and loops until the rolling windows are full.

In Step 308, the FFT is taken of the normalized data for the torque, the differential pressure, and the weight on bit. The transformed data is stored in separate channels. Step 308 produces three new time series channels, in addition to 4 initial time series channels. The time series channels, after this step, include seven channels: the torque, the differential pressure, the weight on bit, the rotations per minute, the FFT for the torque, the FFT for the differential pressure, and FFT for weight on bit. Seven time series channels, in this example, include 1,050 data points associated with one iteration of the 30 seconds rolling time window.

In Step 309, each of the seven time series channels are inputted into a function that generates a cubic B-spline representation of each channel. The cubic B-spline representation of each channel generates a set of coefficients of a piece-wise polynomial curve that are highly related to the shape of the curve. In this example, this process reduces the 1050 values associated with the current iteration down to a representation of 77 values.

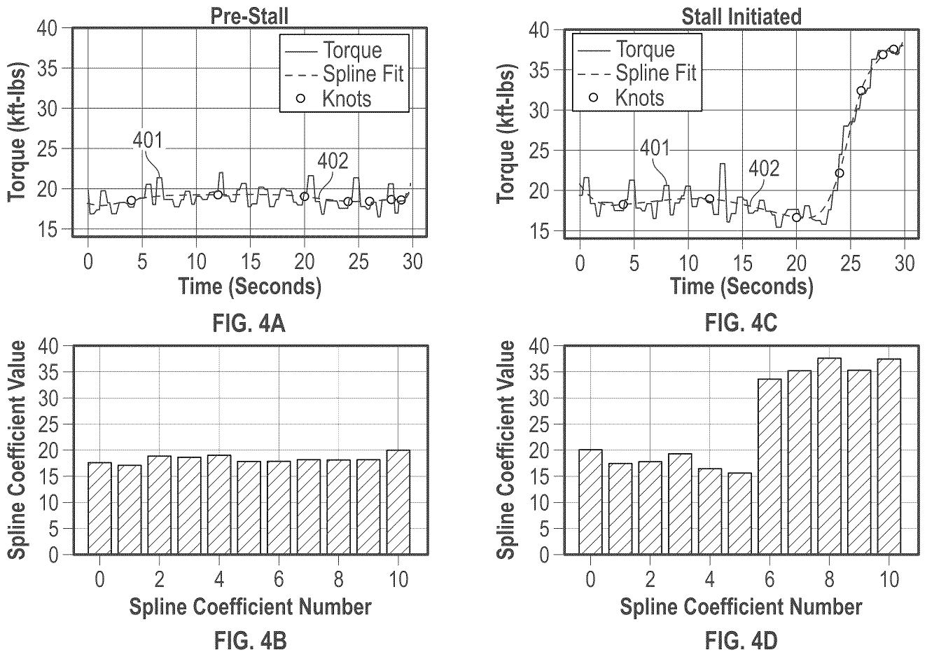

FIGS. 4A-D, show application of the cubic B-spline (402) function to the normalized torque (401). In total, this process reduces the 1,050 data points associated with the current iteration down to a representation of only 77 data points. FIGS. 4A and 4C show generated spline coefficients and a piece-wise polynomial curve (402), based on normalized torque (401) and FFT for normalized torque for pre-stall conditions and for stall-initiated conditions, respectively. Further, FIGS. 4B and 4D show B-spline coefficient amplitudes generated for FIGS. 4A and 4C, respectively.

In Step 310, a dimension of data is reduced using the PCA. The PCA is used to reduce the dimension of this data set from 77 data points to 50 data points. Further, in Step 311, the reduced 50 data points are inputted into the XGBoost machine learning model. The XGBoost is pretrained using historical data. The output of XGBoost is a probability of a motor stall having occurred, based on its previous training experience. Finally, using the probability of a stall occurring, a tunable probability threshold is set, above which the stall prediction for a stall occurring is sent. This threshold was set to 0.7 to find a reasonable balance between the frequencies of false positive and false negative detections. The probability of a motor stall having occurred is always returned by the algorithm.

In Step 312, a determination is made based on the value of probability of a stall having occurred being greater or equal to a predetermined threshold. In Step 313, if the value of probability of a stall having occurred is not greater or equal to the predetermined threshold, the probability of the stall is reported to the user and the system continues to operate without interruptions.

Alternatively, in Step 314, when the value of probability of a stall having occurred is greater or equal to the predetermined threshold the system may notify the user that the probability of the motor stall met or exceeded the threshold. Additionally, the system may instigate an automatic recovery sequence when the stall prediction is raised.

This disclosure is advantageous over the prior art because the use of the machine learning disclosed in detection of the motor stall is a novel technique and the prior art has very different methods for detecting motor stalls compared to this disclosure. Advantageous benefit of this disclosure is that the machine learning algorithm XGBoost makes the best use of the information at hand and computes real probabilities of a stall occurring. The methods in prior art are non-statistical methods that need to be manually tuned for good performance, but that performance is not likely to be optimal without using more advanced statistical methods such as in the proposed disclosure.

For example, in stalls that occur deep in the well and have a substantial time delay between the increase in torque and increase in differential pressure seen at surface, the method described above may be used to detect a stall probability. The method responds to the initial large torque response by increasing the output probability of stall, but this value is typically in the range of 0.3-0.5. It is only after the following increase in differential pressure, which can be delayed by several seconds, that the method increases the stall probability enough to trigger a detection.

The method disclosed herein is also unique for utilizing FFT data of torque, which allows it to differentiate changes in torque that are periodic versus those that are from stalls. The method is trained over historical data that was manually labeled.

In one example, in addition to this training set, a set of 23 motor stalls was used to validate that the algorithm performed well on unseen data. In this example data set, an accuracy of over 80% was achieved, compared to less than 50% for more traditional methods. For the cases where a stall was detected using the method disclosed herein, 95% were actual stalls, implying a high level of confidence. In addition, more than 85% of the detected stalls had a reaction time less than 4 seconds.

Embodiments may be implemented on any suitable computing device, such as the computer system shown in FIG. 5. FIG. 5 is a block diagram of a computer system (500) used to provide computational functionalities associated with described algorithms, methods, functions, processes, flows, and procedures as described in the instant disclosure, according to an implementation. Additionally, the embodiments may be implemented as a standalone software or a plug-in using another software to operate. The illustrated computer (500) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (500) may include a computer that includes an input device, such as a keypad, keyboard, touch screen, or other device that can accept user information, and an output device that conveys information associated with the operation of the computer (500), including digital data, visual, or audio information (or a combination of information), or a GUI.

The computer (500) can serve in a role as a client, network component, a server, a database or other persistency, or any other component (or a combination of roles) of a computer system for performing the subject matter described in the instant disclosure. The illustrated computer (500) is communicably coupled with a network (510). In some implementations, one or more components of the computer (500) may be configured to operate within environments, including cloud-computing-based, local, global, or other environment (or a combination of environments).

At a high level, the computer (500) is an electronic computing device operable to receive, transmit, process, store, or manage data and information associated with the described subject matter. According to some implementations, the computer (500) may also include or be communicably coupled with an application server, e-mail server, web server, caching server, streaming data server, business intelligence (BI) server, or other server (or a combination of servers).

The computer (500) can receive requests over network (510) from a client application (for example, executing on another computer (500) and responding to the received requests by processing the said requests in an appropriate software application). In addition, requests may also be sent to the computer (500) from internal users (for example, from a command console or by other appropriate access method), external or third-parties, other automated applications, as well as any other appropriate entities, individuals, systems, or computers.

Each of the components of the computer (500) can communicate using a system bus (570). In some implementations, any or all of the components of the computer (500), both hardware or software (or a combination of hardware and software), may interface with each other or the interface (520) (or a combination of both) over the system bus (570) using an application programming interface (API) (550) or a service layer (560) (or a combination of the API (550) and service layer (560). The API (550) may include specifications for routines, data structures, and object classes. The API (550) may be either computer-language independent or dependent and refer to a complete interface, a single function, or even a set of APIs. The service layer (560) provides software services to the computer (500) or other components (whether or not illustrated) that are communicably coupled to the computer (500). The functionality of the computer (500) may be accessible for all service consumers using this service layer. Software services, such as those provided by the service layer (560), provide reusable, defined business functionalities through a defined interface. For example, the interface may be software written in JAVA, C++, or other suitable language providing data in extensible markup language (XML) format or other suitable format. While illustrated as an integrated component of the computer (500), alternative implementations may illustrate the API (550) or the service layer (560) as stand-alone components in relation to other components of the computer (500) or other components (whether or not illustrated) that are communicably coupled to the computer (500). Moreover, any or all parts of the API (550) or the service layer (560) may be implemented as child or sub-modules of another software module, enterprise application, or hardware module without departing from the scope of this disclosure.

The computer (500) includes an interface (520). Although illustrated as a single interface (520) in FIG. 5, two or more interfaces (520) may be used according to particular needs, desires, or particular implementations of the computer (500). The interface (520) is used by the computer (500) for communicating with other systems in a distributed environment that are connected to the network (510). Generally, the interface (520 includes logic encoded in software or hardware (or a combination of software and hardware) and operable to communicate with the network (510). More specifically, the interface (520) may include software supporting one or more communication protocols associated with communications such that the network (510) or interface's hardware is operable to communicate physical signals within and outside of the illustrated computer (500).

The computer (500) includes at least one computer processor (530). Although illustrated as a single computer processor (530) in FIG. 5, two or more processors may be used according to particular needs, desires, or particular implementations of the computer (500). Generally, the computer processor (530) executes instructions and manipulates data to perform the operations of the computer (500) and any algorithms, methods, functions, processes, flows, and procedures as described in the instant disclosure.

The computer (500) also includes a memory (508) that holds data for the computer (500) or other components (or a combination of both) that can be connected to the network (510). For example, memory (508) can be a database storing data consistent with this disclosure. Although illustrated as a single memory (508) in FIG. 5, two or more memories may be used according to particular needs, desires, or particular implementations of the computer (500) and the described functionality. While memory (508) is illustrated as an integral component of the computer (500), in alternative implementations, memory (508) can be external to the computer (500).

The application (540) is an algorithmic software engine providing functionality according to particular needs, desires, or particular implementations of the computer (500), particularly with respect to functionality described in this disclosure. For example, application (540) can serve as one or more components, modules, applications, etc. Further, although illustrated as a single application (540), the application (540) may be implemented as multiple applications (540) on the computer (500). In addition, although illustrated as integral to the computer (500), in alternative implementations, the application (540) can be external to the computer (500).

There may be any number of computers (500) associated with, or external to, a computer system containing computer (500), each computer (500) communicating over network (510). Further, the term “client,” “user,” and other appropriate terminology may be used interchangeably as appropriate without departing from the scope of this disclosure. Moreover, this disclosure contemplates that many users may use one computer (500), or that one user may use multiple computers (500).

In some embodiments, the computer (500) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for detecting a motor stall comprising:
obtaining, in real time, actual or calculated values of sensors comprising at least one of a top drive torque value, a differential pressure value, a surface weight on bit value, or a top drive rotational velocity value;
caching, using the computer processor, the obtained values in continuous rolling windows;
computing, using a computer processor, a spline representation of the cached sensor values or values derived from the cached sensor values to obtain a spline data set; and
determining, using the computer processor, a presence of the motor stall using the spline data set.

2. The method of claim 1, further comprising:
calculating, using the computer processor, a mean and a standard deviation of the obtained values in a first predetermined time period;
normalizing, using the computer processor and the mean and standard deviation of the first predetermined time period, the obtained values in a second predetermined time period to obtain normalized values;
computing, using the computer processor, a Fast Fourier Transform (FFT) of the normalized values to obtain FFT values; and
reducing, using the computer processor, a dimension of the spline data set using a principal component analysis (PCA) to obtain a reduced spline data set.

3. The method of claim 2, wherein the normalization is computed, using the computer processor, by subtracting the mean from the obtained values to obtain a difference and dividing the difference by the standard deviation.

4. The method of claim 1, wherein the spline representation includes a set of coefficients of a piece-wise polynomial curve related to a shape of a curve.

5. The method of claim 1, further comprising
generating, using the computer processor, a report or notification to a user, the report or notification including a detection of the motor stall.

6. The method of claim 5, wherein the presence of the motor stall is determined based on a comparison between a predetermined threshold and a probability based on a machine learning model using the spline data set.

7. The method of claim 1, further comprising:
initiating, using the computer processor, an automatic recovery sequence of the motor stall.

8. The method of claim 7, wherein the recovery sequence comprises at least one of stopping lowering of a drill string, reducing or releasing a torque, reducing a weight on bit, reducing a pump flow rate, stopping a top drive rotation, picking up the drill string, or turning off one or more pumps.

9. A non-transitory computer readable medium storing instructions executable by a computer processor, the instructions comprising functionality for:
obtaining, in real time, actual or calculated values of sensors comprising at least one of a top drive torque value, a differential pressure value, a surface weight on bit value, or a top drive rotational velocity value;
caching the obtained values in continuous rolling windows;
computing a spline representation of the cached sensor values or values derived from the cached sensor values to obtain a spline data set; and
determining a presence of a motor stall using the spline data set.

10. The non-transitory computer readable medium of claim 9, further comprising:
calculating a mean and a standard deviation of the obtained values in a first predetermined time period;
normalizing, using the mean and standard deviation of the first predetermined time period, the obtained values in a second predetermined time period to obtain normalized values;
computing a Fast Fourier Transform (FFT) of the normalized values to obtain FFT values; and
reducing a dimension of the spline data set using a principal component analysis (PCA) to obtain a reduced spline data set.

11. The non-transitory computer readable medium of claim 10, wherein the normalization is computed, using the computer processor, by subtracting the mean from the obtained values to obtain a difference and dividing the difference by the standard deviation.

12. The non-transitory computer readable medium of claim 9, wherein the spline representation includes a set of coefficients of a piece-wise polynomial curve related to a shape of a curve.

13. The non-transitory computer readable medium of claim 9, further comprising:
generating, using the computer processor, a report or notification to a user, the report or notification including a detection of the motor stall.

14. The non-transitory computer readable medium of claim 9, further comprising:
initiating, using the computer processor, an automatic recovery sequence of the motor stall.

15. The non-transitory computer readable medium of claim 13, wherein the presence of the motor stall is determined based on a comparison between a predetermined threshold and a probability based on a machine learning model using the spline data set.

16. The non-transitory computer readable medium of claim 14, wherein the recovery sequence comprises at least one of stopping lowering of a drill string, reducing or releasing a torque, reducing a weight on bit, reducing a pump flow rate, stopping a top drive rotation, picking up the drill string, or turning off one or more pumps.

17. A system comprising:
a plurality of sensors; and
a motor stall detector comprising a computer processor, wherein the motor stall detector is coupled to the plurality of sensors, the motor stall detector comprising functionality for:
obtaining, in real time, actual or calculated values of sensors comprising at least one of a top drive torque value, a differential pressure value, a surface weight on bit value, or a top drive rotational velocity value;
caching the obtained values in continuous rolling windows; computing a spline representation of the cached sensor values or values derived from the sensor values to obtain a spline data set t; and
determining a presence of the motor stall using the spline data set.

18. The system of claim 17, wherein the motor stall detector further comprises functionality for:
generating, using the computer processor, a report or notification to a user, the report or notification including a detection of the motor stall.

19. The system of claim 17, wherein the motor stall detector further comprises functionality for:
initiating, using the computer processor, an automatic recovery sequence of the motor stall.

20. The system of claim 19, wherein the recovery sequence comprises at least one of stopping lowering of a drill string, reducing or releasing a torque, reducing a weight on bit, reducing a pump flow rate, stopping a top drive rotation, picking up the drill string, or turning off one or a plurality of pumps.
